(19) United States
(12) Patent Application Publication
(10) Pub. No.: US 2025/0330760 A1
(43) Pub. Date: Oct. 23, 2025

(54) METHODS AND SYSTEMS FOR IMMERSIVE 3DOF/6DOF AUDIO RENDERING

(71) Applicant: Dolby International AB, Dublin (IE)

(72) Inventors: Stefan BRUHN, Sollentuna (SE); Christof Joseph FERSCH, Neumarkt (DE); Panji SETIAWAN, Munich (DE); Leon TERENTIV, Erlangen (DE)

(73) Assignee: Dolby International AB, Dublin (IE)

(21) Appl. No.: 18/853,015

(22) PCT Filed: Mar. 31, 2023
(86) PCT No.: PCT/EP2023/058585

§ 371 Date: Sep. 30, 2024

Related U.S. Application Data
(60) Provisional application No. 63/326,063, filed on Mar. 31, 2022.
(60) Provisional application No. 63/490,197, filed on Mar. 14, 2023.

(51) Int. Cl. H04S 7/00

(52) U.S. Cl. CPC H04S 7/30

(57) ABSTRACT

Described herein is a method of rendering audio, the method including: receiving, at a first renderer, first audio data and first metadata for the first audio data, the first metadata including one or more canonical rendering parameters; processing, at the first renderer, the first metadata and optionally the first audio data for generating second metadata and optionally second audio data, wherein the processing includes generating one or more first digested rendering parameters based on the one or more canonical rendering parameters; providing, by the first renderer, the second metadata and optionally the second audio data for further processing by a second renderer, the second metadata including the one or more first digested rendering parameters and optionally a first portion of the one or more canonical rendering parameters. Described is also a further method of rendering audio, respective systems and computer program products.

### CROSS-REFERENCE TO RELATED APPLICATIONS

This application claims priority of the following priority applications: U.S. provisional application 63/326,063 (reference: D22023USP1), filed 31 Mar. 2022; and US provisional application 63/490,197 (reference: D22023USP2), filed on 14 Mar. 2023, all of which are incorporated herein by reference in their entirety.

### TECHNICAL FIELD

The present disclosure relates generally to methods of rendering audio. In particular, the present disclosure relates to rendering audio by (a rendering chain of) two or more renderers. The present disclosure relates further to respective systems and computer program products. While some embodiments will be described herein with particular reference to that disclosure, it will be appreciated that the present disclosure is not limited to such a field of use and is applicable in broader contexts.

### BACKGROUND

Any discussion of the background art throughout the disclosure should in no way be considered as an admission that such art is widely known or forms part of common general knowledge in the field.

Extended Reality XR (e.g., Augmented Reality (AR)/Mixed Reality (MR)/Virtual Reality (VR)) may increasingly rely on very power limited end devices. AR glasses are a prominent example. To make them as lightweight as possible, they cannot be equipped with heavy batteries. Consequently, to enable reasonable operation times, only very complexity constrained numerical operations are possible on the processors included in them. On the other hand, immersive audio is an essential media component of XR services. This service may typically support adjusting the presented immersive audio/visual scene in response to 3DoF or 6DoF user (head) movements. To carry out the corresponding immersive audio renditions at high quality requires typically high numerical complexity.

There is thus an existing need for improved rendering of immersive audio that, in particular, allows to effectively split the computational burden.

### SUMMARY

In accordance with a first aspect of the present disclosure there is provided a method of rendering audio. The method may include receiving, at a first renderer, first audio data and first metadata for the first audio data, the first metadata including one or more canonical rendering parameters. The method may further include processing, at the first renderer, the first metadata and optionally the first audio data for generating second metadata and optionally second audio data, wherein the processing includes generating one or more first digested rendering parameters based on the one or more canonical rendering parameters. And the method may include providing, by the first renderer, the second metadata and optionally the second audio data for further processing by a second renderer, the second metadata including the one or more first digested rendering parameters and optionally a first portion of the one or more canonical rendering parameters.

In some embodiments, some or all of the one or more first digested rendering parameters may be derived from a combination of at least two canonical rendering parameters.

In some embodiments, the generating the one or more first digested rendering parameters, at the first renderer, may further involve calculating the one or more first digested rendering parameters based on (e.g., to represent) an approximated (e.g., first order) (digest) renderer model with respect to the one or more canonical rendering parameters.

In some embodiments, the calculating may involve calculating a first or higher order Taylor expansion of renderer model based on the one or more canonical rendering parameters.

In some embodiments, the method may further include receiving, at the first renderer, one or more external parameters, wherein the processing, at the first renderer, may further be based on the one or more external parameters.

In some embodiments, the one or more external parameters may include 3DOF/6DOF tracking parameters, wherein the processing, at the first renderer, may further be based on the tracking parameters.

In some embodiments, the method may further include receiving, at the first renderer, timing information indicative of a delay between the first and the second renderer, and wherein the processing, at the first renderer, may further be based on the timing information.

In some embodiments, the method may further include, receiving, at the first renderer, captured audio from the second renderer, and wherein the processing, at the first renderer, may further be based on the captured audio.

In some embodiments, the further processing by the second renderer may include rendering, at the second renderer, output audio based on the second metadata and optionally the second audio data.

In some embodiments, the rendering, at the second renderer, the output audio may further be based on one or more local parameters available at the second renderer.

In some embodiments, the second audio data may be primary pre-rendered audio data.

In some embodiments, the primary prerendered audio data may include one or more of monaural audio, binaural audio, multi-channel audio, First Order Ambisonics (FOA) audio or Higher Order Ambisonics (HOA) audio or combinations thereof.

In some embodiments, the first renderer may be implemented on one or more servers, and the second renderer may be implemented on one or more end devices.

In some embodiments, the one or more end devices may be wearable devices.

In some embodiments, the further processing by the second renderer may include processing, at the second renderer, the second metadata and optionally the second audio data for generating third metadata and optionally third audio data, wherein the processing includes generating one or more second digested rendering parameters based on rendering parameters included in the second metadata. And the further processing may include providing, by the second renderer, the third metadata and optionally the third audio data for further processing by a third renderer, the third metadata including the one or more second digested rendering parameters and optionally a second portion of the one or more canonical rendering parameters.

In some embodiments, the further processing by the third renderer may include rendering, at the third renderer, output audio based on the third metadata and optionally the third audio data.

In some embodiments, the rendering, at the third renderer, the output audio may further be based on one or more local parameters available at the third renderer.

In some embodiments, the method may further include receiving, at the first renderer and/or at the second renderer, one or more external parameters, and the processing, at the first renderer and/or at the second renderer, may further be based on the one or more external parameters.

In some embodiments, the one or more external parameters may include 3DOF/6DOF tracking parameters, wherein the processing, at the first renderer and/or at the second renderer, may further be based on the tracking parameters.

In some embodiments, the method may further include receiving, at the second renderer, timing information indicative of a delay between the second and the third renderer, wherein the processing, at the second renderer, may further be based on the timing information.

In some embodiments, the method may further include, receiving, at the first renderer, captured audio from the third renderer, and wherein the processing, at the first renderer, may further be based on the captured audio.

In some embodiments, the generating the one or more second digested rendering parameters may be based on the first portion of the one or more canonical rendering parameters.

In some embodiments, the generating the one or more second digested rendering parameters may further be based on the one or more first digested rendering parameters.

In some embodiments, the second portion of the one or more canonical rendering parameters may be smaller than the first portion of the one or more canonical rendering parameters.

In some embodiments, the third audio data may be secondary pre-rendered audio data.

In some embodiments, the secondary prerendered audio data may include one or more of monaural audio, binaural audio, multi-channel audio, First Order Ambisonics (FOA) audio or Higher Order Ambisonics (HOA) audio or combinations thereof.

In some embodiments, the first and second renderers may be implemented on one or more servers, and the third renderer may be implemented on one or more end devices.

In some embodiments, the one or more end devices may be wearable devices.

In some embodiments, the canonical rendering parameters may be rendering parameters related to independent audio features.

In some embodiments, the generating the one or more digested rendering parameters may include performing scene simplification.

In some embodiments, the first, second and/or third metadata may further include one or more local canonical rendering parameters.

In some embodiments, the first, second and/or third metadata may further include one or more local digested rendering parameters.

In some embodiments, the one or more local canonical rendering parameters or the one or more local digested rendering parameters may be based on one or more device or user parameters including at least one of a device orientation parameter, a user orientation parameter, a device position parameter, a user position parameter, user personalization information or user environment information.

In some embodiments, the first, second or third audio data may further include locally captured or locally generated audio data.

In accordance with a second aspect of the present disclosure there is provided a method of rendering audio. The method may include receiving, at an intermediate renderer, pre-processed metadata and optionally pre-rendered audio data. The pre-processed metadata may include one or more of digested and/or canonical rendering parameters. The method may further include processing, at the intermediate renderer, the pre-processed metadata and optionally the pre-rendered audio data for generating secondary pre-processed metadata and optionally secondary pre-rendered audio data. The processing may include generating one or more secondary digested rendering parameters based on the rendering parameters included in the pre-processed metadata. And the method may include providing, by the intermediate renderer, the secondary pre-processed metadata and optionally the secondary pre-rendered audio data for further processing by a subsequent renderer. The secondary pre-processed metadata may include the one or more secondary digested rendering parameters and optionally one or more of the canonical rendering parameters.

In accordance with a third aspect of the present disclosure there is provided a method of rendering audio. The method may include receiving, at a first renderer, initial first audio data having one or more canonical properties. The method may further include generating, at the first renderer, from the initial first audio data first digested audio data and one or more first digested rendering parameters associated with the first digested audio data based on the one or more canonical properties. The first digested audio data may have fewer canonical properties than the initial first audio data. And the method may include providing, by the first renderer, the first digested audio data and the one or more first digested rendering parameters for further processing by a second renderer.

In some embodiments, the method may further include receiving, at the first renderer, one or more external parameters, wherein the generating, at the first renderer, may further be based on the one or more external parameters.

In some embodiments, the one or more external parameters may include 3DOF/6DOF tracking parameters, wherein the generating, at the first renderer, may further be based on the tracking parameters.

In some embodiments, the method may further include receiving, at the first renderer, timing information indicative of a delay between the first and the second renderer, wherein the generating, at the first renderer, may further be based on the timing information.

In some embodiments, the delay may be calculated at the second renderer.

In some embodiments, the method may further include adjusting the tracking parameters based on the timing information. Optionally, the adjusting may include predicting the tracking parameters based on the timing information.

In some embodiments, the adjusting may be performed at the second renderer.

In some embodiments, the further processing by the second renderer may include rendering, at the second renderer, output audio based on the first digested audio data and at least partly on the one or more first digested rendering parameters.

In some embodiments, the rendering, at the second renderer, the output audio may further be based on one or more local parameters available at the second renderer.

In some embodiments, the further processing by the second renderer may include processing, at the second renderer, the first digested audio data and optionally the one or more first digested rendering parameters for generating second digested audio data and one or more second digested rendering parameters. The second digested audio data may have fewer canonical properties than the first digested audio data. And the further processing by the second renderer may include providing, by the second renderer, the second digested audio data and the one or more second digested rendering parameters for further processing by a third renderer.

In some embodiments, the method may further include receiving, at the first renderer and/or at the second renderer, one or more external parameters, wherein the generating at the first renderer and/or the processing at the second renderer may further be based on the one or more external parameters.

In some embodiments, the one or more external parameters may include 3DOF/6DOF tracking parameters, wherein the generating at the first renderer and/or the processing at the second renderer may further be based on the tracking parameters.

In some embodiments, the method may further include receiving, at the second renderer, timing information indicative of a delay between the second and the third renderer, wherein the processing, at the second renderer, may further be based on the timing information.

In some embodiments, the delay may be calculated at the third renderer.

In some embodiments, the method may further include adjusting the tracking parameters based on the timing information. Optionally, the adjusting may include predicting the tracking parameters based on the timing information.

In some embodiments, the adjusting may be performed at the third renderer.

In some embodiments, the further processing by the third renderer may include rendering, at the third renderer, output audio based on the second digested audio data and at least partly on the one or more second digested rendering parameters.

In some embodiments, the rendering, at the third renderer, the output audio may further be based on one or more local parameters available at the third renderer.

In some embodiments, the canonical properties may include one or more of extrinsic and/or intrinsic canonical properties. An extrinsic canonical property may be associated with one or more canonical rendering parameters. An intrinsic canonical property may be associated with a property of the audio data to retain the potential to be rendered perfectly in response to an external renderer parameter.

In some embodiments, the one or more canonical rendering parameters may be tracking parameters.

In some embodiments, the tracking parameters may be 3DOF/6DOF tracking parameters.

In some embodiments, the method may further include receiving, at the first renderer, timing information indicative of a delay between the first and the second renderer, wherein the processing, at the first renderer, may further be based on the timing information.

In some embodiments, the method may further include adjusting the tracking parameters based on the timing information, wherein optionally the adjusting may include predicting the tracking parameters based on the timing information.

In some embodiments, some or all of the one or more digested rendering parameters may be derived from a combination of at least two canonical properties.

In some embodiments, some or all of the one or more digested rendering parameters may be derived from at least one canonical property and respective initial or digested audio data.

In some embodiments, the generating the one or more digested rendering parameters, at the respective renderer, may further involve calculating the one or more digested rendering parameters to represent an approximated renderer model with respect to the one or more canonical properties.

In some embodiments, the calculating may involve calculating a first or higher order Taylor expansion of a renderer model based on the one or more canonical properties.

In some embodiments, the calculating of the one or more digested rendering parameters may involve multiple renderings.

In some embodiments, the calculating of the one or more digested rendering parameters may involve analyzing signal properties of the initial first audio data to identify parameters relating to a sound reception model.

In some embodiments, the first renderer may be implemented on one or more servers.

In some embodiments, the second renderer or the third renderer may be implemented on one or more end devices.

In some embodiments, the one or more end devices may be wearable devices.

In accordance with a fourth aspect of the present disclosure there is provided a method of rendering audio. The method may include receiving, at an intermediate renderer, digested audio data having one or more canonical properties and one or more digested rendering parameters. The method may further include processing, at the intermediate renderer, the digested audio data and optionally the one or more digested rendering parameters for generating secondary digested audio data and one or more secondary digested rendering parameters. The secondary digested audio data may have fewer canonical properties than the digested audio data. And the method may include providing, by the intermediate renderer, the secondary digested audio data and the one or more secondary digested rendering parameters for further processing by a subsequent renderer.

In accordance with a fifth aspect of the present disclosure there is provided a system including one or more processors configured to perform operations as described herein.

In accordance with a sixth aspect of the present disclosure there is provided a program comprising instructions that, when executed by a processor, cause the processor to carry out the method as described herein. The program may be stored on a computer-readable storage medium.

It will be appreciated that system (apparatus) features and method steps may be interchanged in many ways. In particular, the details of the disclosed method(s) can be realized by the corresponding system (apparatus), and vice versa, as the skilled person will appreciate. Moreover, any of the above statements made with respect to the method(s) are understood to likewise apply to the corresponding system (apparatus), and vice versa.

### BRIEF DESCRIPTION OF THE DRAWINGS

Example embodiments of the disclosure will now be described, by way of example only, with reference to the accompanying drawings in which:

FIG. 1 illustrates an example of a method of rendering audio according to an embodiment of the disclosure.

FIG. 2 illustrates an example of a system of rendering audio by a first and a second renderer according to an embodiment of the disclosure.

FIG. 3 illustrates a further example of a system of rendering audio by a first and a second renderer according to an embodiment of the disclosure.

FIG. 4 illustrates an example of a system of rendering audio by a first, a second and a third renderer according to an embodiment of the disclosure.

FIG. 5 illustrates a further example of a system of rendering audio by a first, a second and a third renderer according to an embodiment of the disclosure.

FIG. 6 illustrates a further example of a system of rendering audio by a first, a second and a third renderer according to an embodiment of the disclosure.

FIG. 7 illustrates a further example of a system of rendering audio by a first, a second and a third renderer according to an embodiment of the disclosure.

FIG. 8 illustrates an example of a system of rendering audio by a first, a second and a third renderer in the context of 3GPP IVAS and MPEG-I Audio according to an embodiment of the disclosure.

FIG. 9 illustrates an example of a system of rendering audio by a first, a second and a third renderer including local parameters and local audio according to an embodiment of the disclosure.

FIG. 10 illustrates another example of a method of rendering audio according to an embodiment of the disclosure.

FIG. 11 illustrates an example of a system of rendering audio by a first and a second renderer according to an embodiment of the disclosure.

FIG. 12 illustrates a further example of a system of rendering audio by a first, a second and a third renderer according to an embodiment of the disclosure.

FIG. 13 schematically illustrates an example of an apparatus for implementing methods according to embodiments of the disclosure.

### DESCRIPTION OF EXAMPLE EMBODIMENTS

### Overview

One potential solution to address the problem of high computational complexity of immersive audio renditions is to carry out the rendering not on the device itself but rather on some entity of the mobile/wireless network to which the end device is connected or on a powerful mobile UE to which the end device is tethered. In that case, the end device would, for example, only receive the already binaurally rendered audio. The 3DoF/6DoF pose information (head-tracking metadata) would need to be transmitted to the rendering entity (network entity/UE).

The latency for transmissions between end device and network entity/UE is, however, quite high and can be in the order of 100 ms. Performing rendering on the network entity/UE would thus consequently mean to rely on outdated head-tracking metadata and that the binauralized audio played out by the end rendering device is not matching the actual pose of the head/end device. This latency is referred to as motion-to-sound latency. If it is too large, the end user will perceive it as quality degradation and eventually experience motion sickness.

For the video component of the immersive media rendering, this problem is being addressed by split render approaches, where an approximative part of the video scene is rendered by the network entity/UE and final video scene adjustments are carried out on the end device. For audio, however, the field is up to now less explored if at all.

An MPEG-I Audio renderer is an example of a 6DoF audio renderer that could be placed at the network entity/UE and a stripped down or low power version of it could be placed at the end device. The low power version may have certain constraints such as a limited number of channels and objects and a lower order of Higher Order Ambisonics, HOA, (e.g., First Order, FOA). Such a renderer may take channels, objects and HOA signals plus 3DoF/6DoF metadata as input and outputs a binauralized or loudspeaker signal for AR/VR applications. In a specific case of HOA signals rendering, other dedicated 3DoF or 6DoF HOA renderers may be used such as MASA Renderer and MPEG-H Audio HOA renderer.

Often, for HOA contents, it may be better to allow the transmission of HOA signals themselves to the end device. This is motivated by the fact that scene adjustments (e.g., rotation, zoom) are better performed in this domain and the computationally less demanding HOA Binauralization can be performed at the end device. This method may also be preferred to avoid the motion-to-sound latency problem in the split renderer context. In a bitrate constrained scenario which may be happening between the rendering entity and the end device, a lower order HOA is preferred, e.g., an FOA. A proper treatment to the original HOA signals shall be performed other than simply truncating the HOA signals themselves. At the moment there is no specific interface and solution to this problem in the split rendering context.

Doing the binauralization from the HOA/FOA representation at the end device retains all inherent control possibilities of the Ambisonics audio representation to the end device such as the possibility to carry out scene rotations in response to head-tracker (pose) metadata. In that sense, Ambisonics may be regarded as a ‘canonical’ audio representation. In contrast, after binauralization, a two-channel audio signal is obtained with lesser control possibilities. Specifically, a binaural audio signal as such is not head-trackable anymore. However, according to a preferred embodiment, metadata may be associated with the binaural audio signal which may represent information about how to adjust the binaural audio signal (e.g. in terms of loudness or spectral properties) to make it head-trackable again. The process to binauralize the canonical audio representation and generation of such metadata can thus be regarded as converting the canonical audio representation into a digested representation where digest metadata may support the end device to carry out output signal adjustments in response to metadata locally available at the end device. One advantage of this concept is that the operations at the end device may become significantly less complex. Another advantage may be that end devices which are not able to interpret the digest metatdata may still be able to output the binaural audio signal as a fallback.

Notably, while in the following, reference is made to first, second and third renderers, this sequence is merely for explanatory purposes and not intended to be limiting. Any renderer that is followed by another renderer may be a pre-renderer or a first renderer and any renderer that receives pre-rendered data may be an end-renderer or second renderer.

Further, while in the following reference is made to local and external parameters/data, some of the external parameters may also be locally available. In other words, local parameters/data may also be said to be external parameters/data and vice versa.

### Method and System of Rendering Audio

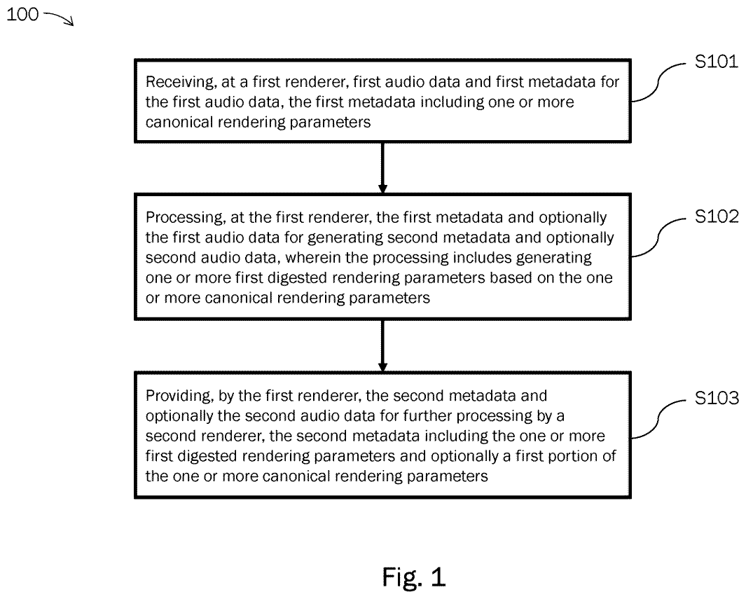

As a solution to the problems posed, the present disclosure describes method and system of rendering audio that allow to effectively split the computational burden and at the same time minimize the motion-to-sound latency. An example of a method of (split) rendering (immersive) audio is illustrated in FIG. 1.

In step S101, at a first renderer, first audio data and first metadata for the first audio data is received. The first metadata include one or more canonical rendering parameters.

In step S102, at the first renderer, the first metadata and optionally the first audio data are processed for generating second metadata and optionally second audio data, wherein the processing includes generating one or more first digested rendering parameters based on the one or more canonical rendering parameters.

Generally, one aspect to be considered with a split render approach for immersive audio, as described herein, is that there may be two kinds of metadata or rendering parameters, canonical (or initial) and digested.

In an embodiment, canonical rendering parameters, which may also be referred to as initial rendering parameters, may be rendering parameters related to independent audio features. Parameters like position, direction, directivity, extent, transitionDistance, interior/exterior and authoring parameters (noDoppler, noDistance, . . . ) are typically canonical, meaning that they allow controlling a certain feature kind of independent of the others. While this is convenient, it may not necessarily lead to the least complex renderer solution. Thus, applying them on a very power limited device in the final render stage on the end device may be less attractive or not possible. Canonical rendering parameters may also be said to be related to/associated with extrinsic canonical properties.

Digested parameters refer to basic audio features like gain, (spectral) shape or time lag and are less computationally intensive when applied to an audio signal during rendering operations. Digest parameters may be obtained by ‘digesting’ a set of canonical parameters associated with the audio (e.g. object metadata) and device parameters like 3DOF orientation or 6DOF orientation and position. In an embodiment, some or all of the (first) digested rendering parameters may be derived from a combination of at least two of the canonical rendering parameters. The term ‘digesting’ as used herein may thus be said to refer to extracting and combining relevant features from respective canonical rendering parameters into a digested rendering parameter that can be applied to an audio signal with reduced complexity. The rendering processing using a digested parameter may thus be less computationally intensive and can thus also be applied on a very power limited device in the final render stage. In an embodiment, some or all of the (second) digested rendering parameters may be derived from a combination of one or more of the canonical rendering parameters and one or more of previously generated (first) digested parameters as described further below. Some or all of the digested rendering parameters may further be derived from one canonical rendering parameter as follows. As a basic example, an object with a (one-dimensional) room coordinate x as single parameter may be assumed. Direct rendering might require firstly calculating a distance between the object and a listener (head-tracker x coordinate) and secondly applying a distance model to attenuate the audio signal dependent on the distance. This may be more or less complex. A digested rendering parameter may then be a simple coefficient by which the end renderer multiplies the x coordinate of the listener to obtain a scaling factor for the audio signal.

Referring again to the example of FIG. 1, in step S103, the second metadata and optionally the second audio data is provided, by the first renderer, for further processing by a second renderer. The second metadata include the one or more first digested rendering parameters and optionally a first portion of the one or more canonical rendering parameters.

The combination of canonical and digested parameters may be used to control the computational complexity of a 3DoF/6DoF Audio renderer, to exactly match the needs of the underlying hardware platform. This approach may be used to build up a chain of two or more renderers, distributed over various components of, e.g., a network, which all contribute to the final experience.

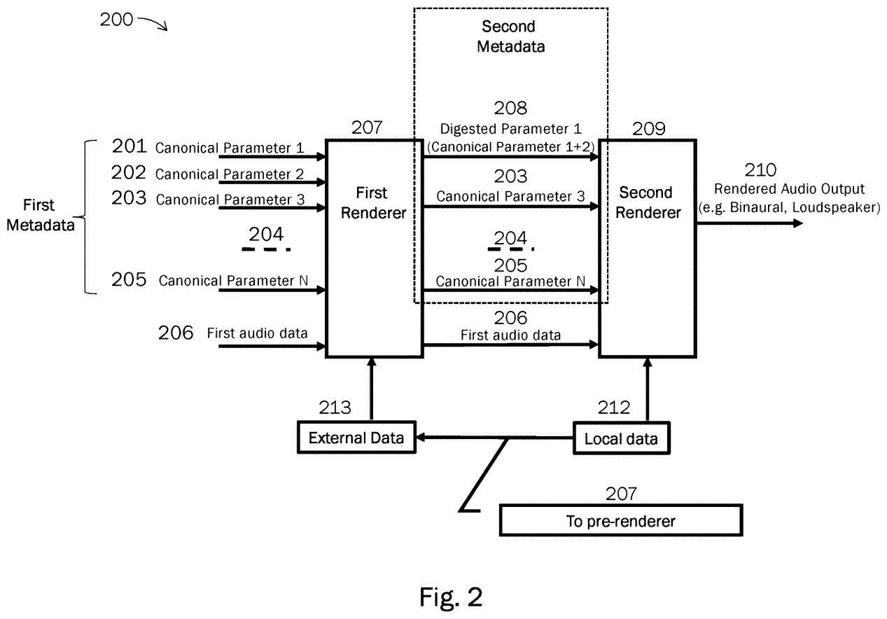

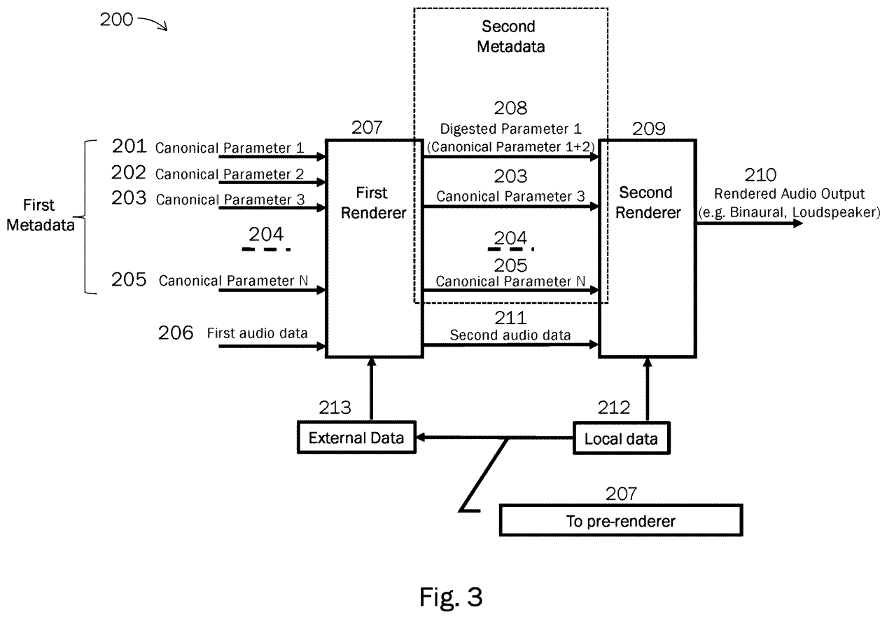

FIGS. 2 and 3 illustrate examples of a system of rendering audio by a chain of a first and a second renderer to implement the method described.

In the examples of FIGS. 2 and 3, the system includes a first renderer 207 that, in an embodiment, may be implemented on one or more servers, for example, in the network or on an EDGE Server, and a second renderer 209 that may be implemented on one or more user's end devices. In an embodiment, the one or more end devices may be wearable devices.

In the examples of FIGS. 2 and 3, the first renderer 207 receives first metadata including a number of N canonical rendering parameters, 201-205. Notably, in an embodiment, some or all of the digested rendering parameters may be derived from a combination of two or more of the canonical rendering parameters. The metadata may include one or more canonical rendering parameters.

The first metadata are processed by the first renderer 207 to generate second metadata 208, 203-205. The second metadata include one or more first digested rendering parameters and optionally a first portion of the one or more canonical rendering parameters. In the examples of FIGS. 2 and 3, the generating the second metadata by the first renderer 207 includes digesting/processing two canonical rendering parameters 201, 202. Resulting from the combined processing of canonical rendering parameters 201, 202, a first digested rendering parameter 208 is generated. It is to be noted that the examples of FIGS. 2 and 3 are non-limiting in that the number of digested rendering parameters generated is also not limited and will depend on the individual use case.

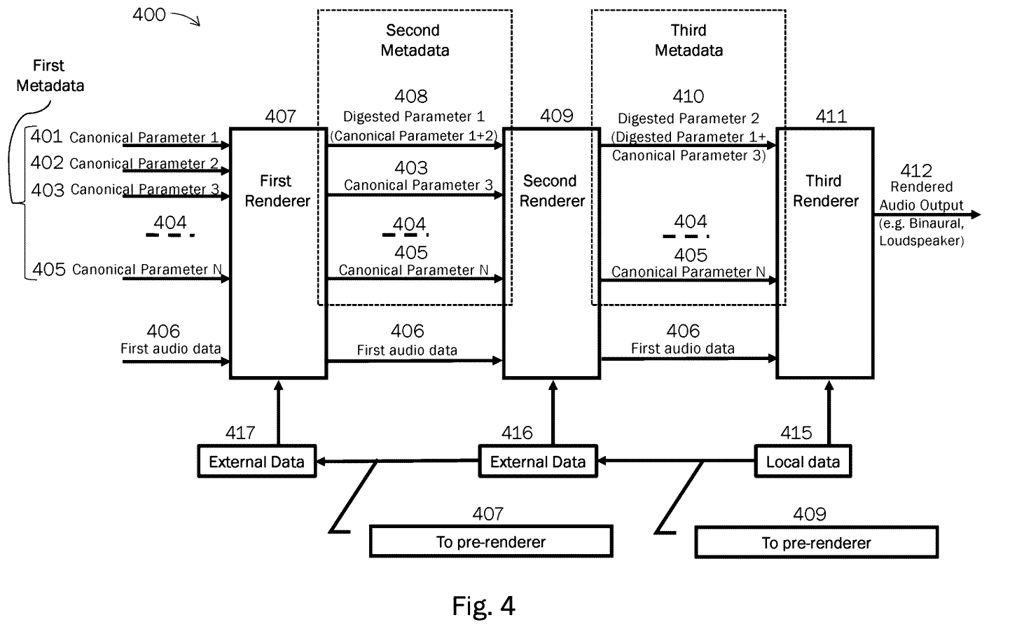

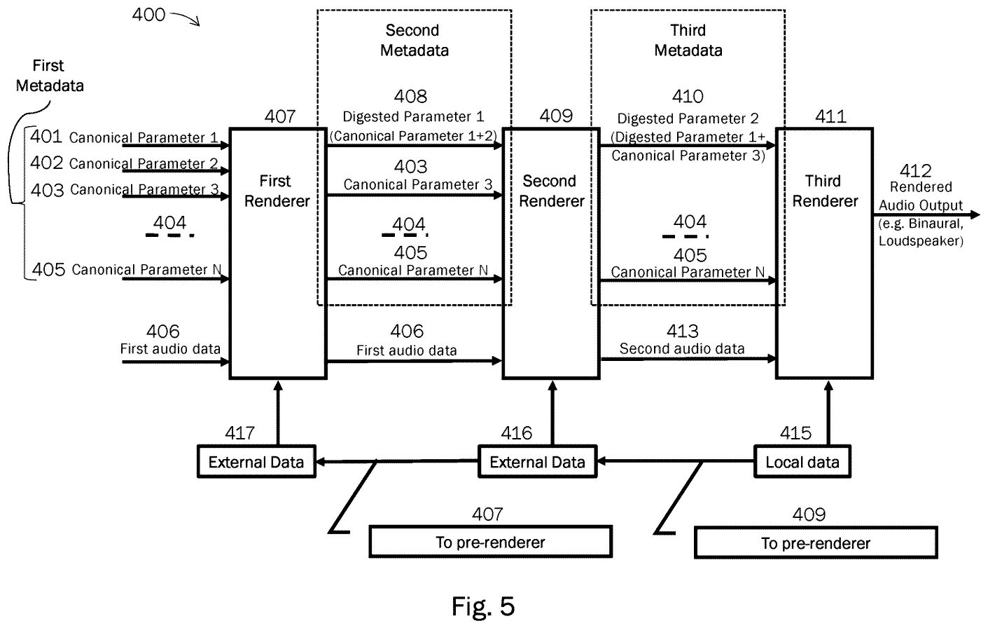

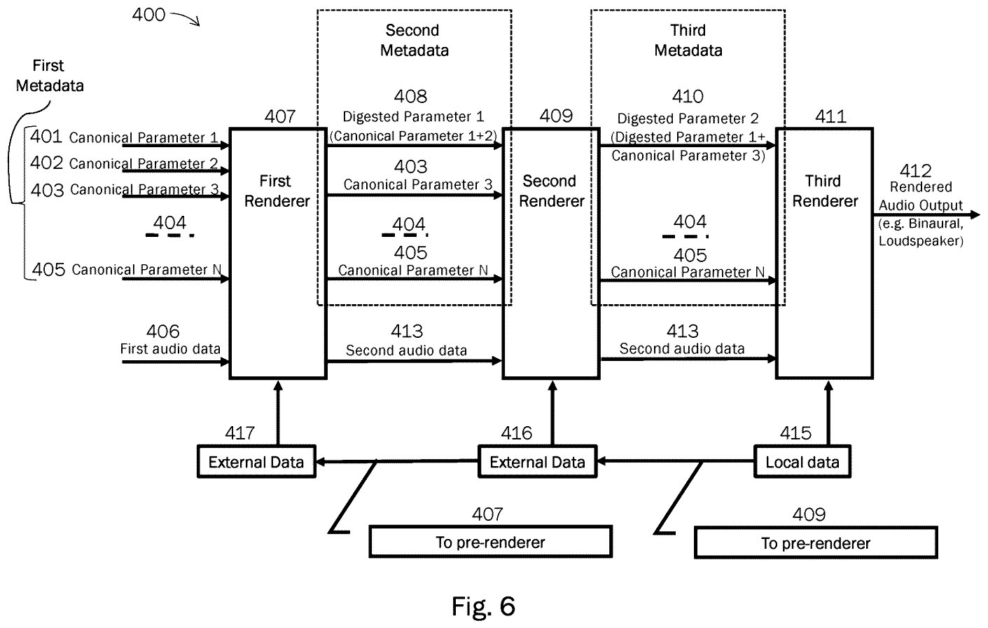

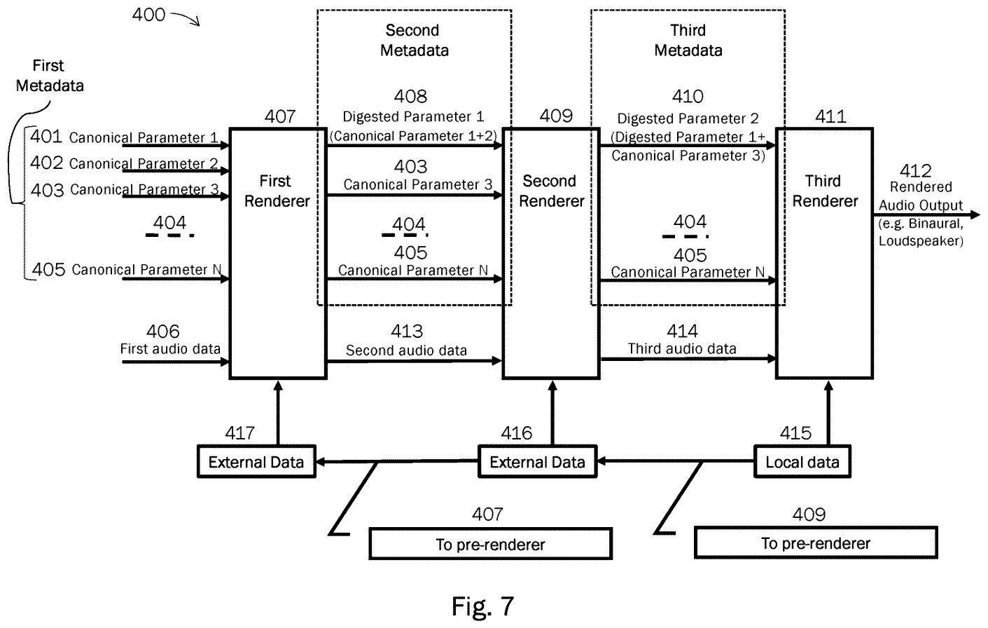

As may be derived from the examples of FIGS. 2 and 3, the second metadata include the first digested rendering parameter 208 as well as a portion of the canonical rendering parameters 203-205 received by the first renderer. Notably, the inclusion of a portion of the canonical rendering parameters into the second metadata is optional and may depend on the use case. The portion of the canonical rendering parameters may be used in the final rendering stage, but may also be used for further intermediate rendering steps in case the chain of renderers includes more than two renderers as illustrated in the examples of FIGS. 4 to 7.

In the examples of FIGS. 2 and 3, the first renderer 207 also receives first audio data 206. Depending on the use case, the first audio data 206 may be processed by the first renderer 207 to generate second audio data 211 as illustrated in the example of FIG. 3. In an embodiment, the second audio data 211 may be primary pre-rendered audio data. The primary pre-rendered audio data may include one or more of monaural audio, binaural audio, multi-channel audio, First Order Ambisonics (FOA) audio or Higher Order Ambisonics (HOA audio) or combinations thereof.

In the examples of FIGS. 2 and 3, the second renderer 209 may be said to be the final renderer performing the final rendering step. That is, in an embodiment, output audio is rendered by the second renderer 209 based on the second metadata and optionally the second audio data 211. Rendering the output audio 210 by the second renderer 209 may further also be based on one or more local parameters 212 available at the second renderer 209. Local parameters 212 may be, for example, head-tracker data. The one or more local parameters 212 may also be transmitted as external parameters 213 to the pre-renderer. Processing, by the first (pre) renderer 207, may then also be based on these external parameters 213. In some embodiments, the one or more external parameters may include 3DOF/6DOF tracking parameters, wherein the processing, at the first renderer, may further be based on the tracking parameters.

Referring now to the examples of FIGS. 4 to 7, the chain of renderers may also include more than two renderers. In the examples of FIGS. 4 to 7, the chain of renderers includes three renderers. In an embodiment, the first renderer 407 and the second renderer 409 may be implemented on one or more servers, for example, in the network and on the EDGE Server. The third renderer 411 may be implemented on one or more user's end devices. The one or more end devices may be wearable devices.

Notably, also in the examples of FIGS. 4 to 7, the first renderer 407 receives first audio data which may optionally be processed by the second renderer 409 and/or the third renderer 411 depending on the use case. In contrast to the examples of FIGS. 2 and 3, in these examples, the second renderer 409 represents an intermediate renderer while the third renderer 411 represents the final renderer performing the final rendering step. In case the first audio data are processed by the first renderer 407, the second audio data thus generated may include pre-rendered, in particular pre-binauralized audio. In an embodiment, similar to the second audio data 413 that may be primary pre-rendered audio data, the third audio data 414 may be secondary pre-rendered audio data. In an embodiment, the secondary prerendered audio data may include one or more of monaural audio, binaural audio, multi-channel audio, object audio, First Order Ambisonics (FOA) audio or Higher Order Ambisonics (HOA) audio or combinations thereof. As may be derived from the examples of FIGS. 4 to 7, the second renderer 409 provides the third metadata 410, 404-405 and optionally the third audio data 414 for further processing by the third renderer 411. While the third renderer 411 may also represent an intermediate renderer, in the examples of FIGS. 4 to 7, the third renderer 411 renders the output audio 412 based on the third metadata 410, 404-405 and optionally the third audio data 414. Rendering the output audio 412 by the third renderer 411 may further also be based on one or more local parameters 415 available at the third renderer 411. Local parameters may be, for example, head-tracker data. The one or more local parameters 415 may also be transmitted as external parameters 416, 417 to the pre-renderers. Processing, by the first and/or the second (pre) renderer 407, 409, may then also be based on these external parameters 416, 417. In some embodiments, the one or more external parameters may include 3DOF/6DOF tracking parameters, wherein the processing, at the first renderer and/or at the second renderer, may further be based on the tracking parameters.

Up to the second rendering stage in FIGS. 4 to 7, the processing is the same as in the examples of FIGS. 2 and 3 described above. In contrast to the examples of FIGS. 2 and 3, at the second renderer 409, the second metadata 408, 403-405 and optionally the second audio data 413 are now processed for generating third metadata 410, 404-405 and optionally third audio data 414. The processing at the second renderer 409 includes generating one or more second digested rendering parameters 410 based on rendering parameters 408, 403-405 included in the second metadata. In this case, as the second metadata may include digested and canonical rendering parameters, the second digested rendering parameter 410 may be derived from a combination of a first digested rendering parameter 408 and a canonical rendering parameter 403 out of the first portion of canonical rendering parameters as illustrated in the examples of FIGS. 4 to 7. Alternatively, or additionally, a second digested rendering parameter may also be derived from a combination of two canonical rendering parameters out of the first portion of canonical rendering parameters. Notably, also the number of second digested rendering parameters generated is not limited and may depend on the use case

The third metadata thus generated include one or more second digested rendering parameters and optionally a second portion of the one or more canonical rendering parameters. In the examples of FIGS. 4 to 7, the third metadata are illustrated to include one of a second digested rendering parameter 410 and a second portion of canonical rendering parameters 404-405. As illustrated in the examples of FIGS. 4 to 7, in an embodiment, the second portion of the one or more canonical rendering parameters 404-405 may be smaller than the first portion of the one or more canonical rendering parameters 403-405.

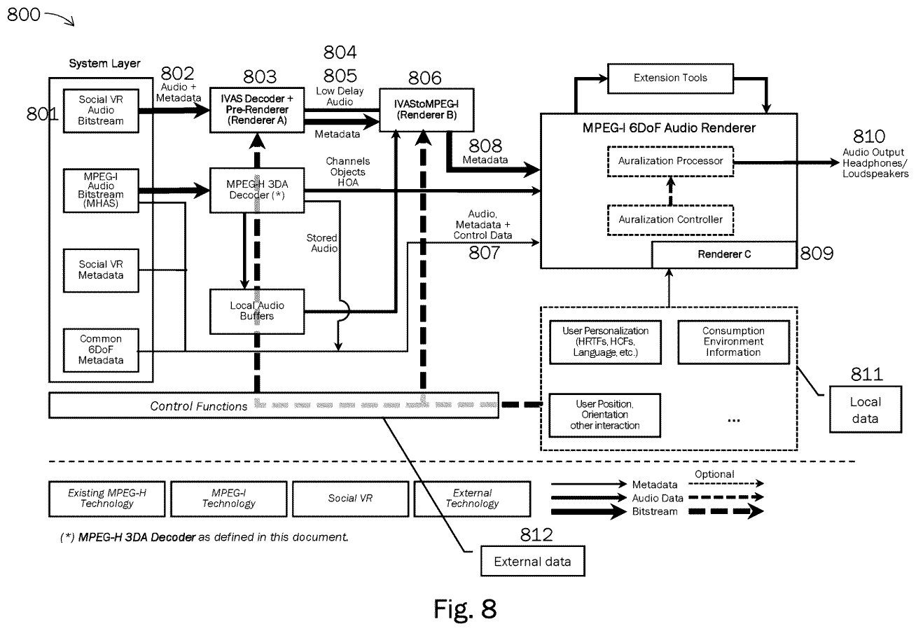

Furthermore, the MPEG-I 6DoF Audio renderer in combination with the 3GPP IVAS codec and renderer as shown in the example of FIG. 8 may be one example where the concept of canonical and digested parameters, and therefore a “split rendering” approach applies. In this example, the “Social VR Audio Bitstream” 801 may be coded using 3GPP IVAS, which contains compressed audio and metadata (Metadata A 802). Metadata A 802 may be a collection of related canonical or digested parameters, or a mix thereof. Renderer A 803 may take Metadata A 802 as input and “convert” it to “Low Delay Audio” 804 and to Metadata B 805. “Low Delay Audio” 804 may be an intermediate audio format, such as pre-binauralized audio. Metadata B 805 may also be a collection of related canonical or digested parameters, or a mix thereof. Renderer B 806 may take Metadata B 805 as input and “convert” it to another audio representation 807 and to Metadata C 808. This another audio representation 807 may be an intermediate audio format, such as pre-binauralized audio. Metadata C 808 may also be a collection of related canonical or digested parameters, or a mix thereof. Renderer C 809 may take Metadata C 808 as input and “convert” it to the final audio representation 810, such as binauralized audio or loudspeaker feeds. Rendering the final audio output representation 810 by Renderer C 809 may further also be based on one or more local parameters/data 811 available at Renderer C 809. Local parameters may be, for example, head-tracker data. The one or more local parameters 811 may also be transmitted as external parameters 812 to the pre-renderers. Processing, by Renderer A 803 and/or Renderer B 806, may then also be based on these one or more external parameters 812.

For example, for a XR use-case, a real listening environment representation may contain local parameters and signals (e.g., local audio, RT60, critical distance, meshes, RIR data, pose, position information, properties of output device (headphones, car speakers) etc.). These local data may be available at the end device side, but it is computationally expensive to apply it there directly. These parameters may be sent to the pre-rendering entity and be processed as external data together with the rest of the data of XR audio scene. The resulted pre-rendered and listener environment adjusted XR audio scene content (together with associated ‘digested’ parameters) are returned to the end device side in a simpler ‘digested’ representation form (suitable for low complexity rendering).

Some pre-rendering processing steps (e.g., listener environment independent ones) can be performed once for many rendering end devices. This can result in additional computational advantages for the multi-user/social XR scenario.

Furthermore, the pre-rendering processing can account of computational/bitrate capabilities and latency requirements associated with rendering end devices. To fulfil the corresponding requirement, a scene simplification step can be performed during conversion of ‘canonical’ parameters into ‘digested’ ones. E.g., this step can include reduction of
update rate
frequency resolution
number of corresponding elements, e.g. by combining two or more audio objects into one

Another example to deal with different computational or bit rate capabilities of the end-rendering device is to associate different sound effects to be produced by the rendition or the corresponding metadata controlling such effects with priority metadata. An end device suffering from resource shortage (permanent of transient computational limits, power limits due to battery drain) may then use the priority information to scale down on sound effects in a controlled way, maintaining best overall user experience given the constraint. The priority metadata may be associated with the received audio or depend on user preference/interaction of the end user or the situational context of the end user (sound ambience, focus of interest, visual scene).

To handle the bitrate constraint scenario for HOA signals end device rendering, the following methods can be done. This assumes that the end device is capable of handling a low power processing such as FOA-to-binaural rendering and/or a simple panning function.
One or more sectoral and/or ambient FOA signals with a possibility to have the additional sector/ambient-based metadata (e.g., direction, sector area) can be extracted and used for the final rendering. For example, the MPEG-H decoded HOA signals can be processed to generate the above format and transmits them to a low power MPEG-I Renderer at the end device.
In case of sources with extent, the reduced order of HOA signals such as the FOAs can also be used to control the extent width at the end-device by additionally including control parameters such as the blurring, mixing, and filter coefficients, as the accompanying metadata.
One or more predominant signals with the accompanying metadata (e.g., directional info) can be extracted and transmitted to the end device. The ambient signal can additionally be transmitted in an FOA format or as a transport signal with the accompanying metadata, e.g., intensity, diffuseness, and spatial energy.
In an extremely low bitrate condition, a parametric representation of HOA signals plus zero or more transport channels may be extracted or simply forwarded (in case the HOA signals are already parametrically encoded as usually done in low bitrate HOA processing scenario) to the end device.

Note that the transport or predominant signals may be rendered by a simple panning function or a channel/object renderer. In such cases, these signals (e.g., transport signals, predominant signals, sectoral and ambient FOAs/HOAs) may be handled properly within the MPEG-I Audio context for example by additionally declaring the signals with the accompanying metadata information. The existing MPEG-I Audio signal properties (metadata information, interface) are declared below as a reference.

A 3DoF/6DoF audio renderer (e.g., MPEG-I Audio renderer) may offer an input interface for canonical parameters, as further detailed in Table 1, Table 2 and Table 3. In addition to those parameters, a 3DoF/6DoF Audio renderer may offer an input interface for digested parameters, e.g. being a combination of canonical parameters listed above and in Table 1, Table 2 and Table 3. Furthermore, 3DoF/6DoF Audio renderer may offer an input interface for a combination of canonical and digested parameters. In one example, digested parameters may be a 3DoF representation derived from 6DoF parameters.

TABLE 1
MPEG-I Audio ObjectSource Parameters
ObjectSource

| Attribute | Type | Flags | Default | Description |
|---|---|---|---|---|
| id | ID | R | | Identifier |
| position | Position | R, M | | Position |
| orientation | Rotation | O, M | (0° 0° 0°) | Orientation |
| cspace | Coordinate | O | relative | Spatial frame of |
| | space | | | reference |
| active | Boolean | O, M | true | If true, then |
| | | | | render this source |
| gainDb | Gain | O, M | 0 | Gain (dB) |
| refDistance | Float >0 | O | 1 | Reference distance (m) |
| | | | | (see comment below) |
| signal | AudioStream | R, M | | Audio stream |
| | ID | | | |
| extent | Geometry | O, M | none | Spatial extent |
| | ID | | | |
| directivity | Directivity | O, M | none | Sound radiation pattern |
| | ID | | | |
| directiveness | Value | O, M | 1 | Directiveness (see 3.4.1) |
| aparams | Authoring | O | none | Authoring parameters |
| | parameters | | | |
| mode | Playback | O | continuous | Playback mode |
| | mode | | | {“continuous”, “event”} |
| play | Boolean | O, M | False | Playback enabled? |

TABLE 2
MPEG-I Audio HOASource Parameters
HOASource

| Attribute | Type | Flags | Default | Description |
|---|---|---|---|---|
| id | ID | R | | Identifier |
| position | Position | R, M | | Position |
| orientation | Rotation | O, M | (0° 0° 0°) | Orientation |
| cspace | Coordinate | O, M | relative | Spatial frame of reference |
| | space | | | Cannot be set to ‘user’, when |
| | | | | is6DOF == True |
| active | Boolean | O, M | true | If true, then render this source |
| gainDb | Gain | O, M | 0 | Gain (dB) |
| signal | AudioStream | R, M | | Audio stream |
| | ID | | | |
| aparams | Authoring | O | none | Authoring parameters |
| | parameters | | | |
| mode | Playback | O | continuous | Playback mode {“continuous”, |
| | mode | | | “event”} |
| play | Boolean | O, M | False | Playback enabled? |
| extent | Geometry ID | O, M | none | Region of validity, spatial |
| | | | | extent |
| extentTransform | Boolean | O | True | When an extent is defined, turns |
| | | | | on/off the external rendering of |
| | | | | an interior source or the internal |
| | | | | rendering of an exterior source. |
| transitionDistance | Value | O | 0 | When an extent is defined, |
| | | | | determines the transition area |
| | | | | between external and internal |
| | | | | representation (m) (see FIG. 8). |
| representation | Integer | R | | Interior or exterior HOA |
| | | | | expansion |
| | | | | 0 = interior, 1 = exterior |
| is6DoF | Boolean | O, M | False | If True, the source is rendered |
| | | | | in 6DoF within its region of |
| | | | | validity (or everywhere if no |
| | | | | extent is defined). Also enables |
| | | | | the following attributes when |
| | | | | True: group, refDistance |
| group | ID | O, M | none | Parent HOAGroup |
| refDistance | Float >=0 | O | 0 - interior | Reference distance (m) (see |
| | | | representation | Reference Distance section |
| | | | 1 - exterior | below) |
| | | | representation | For an internal HOASource the |
| | | | | distance is from the |
| | | | | origin/center of the extent, |
| | | | | while for an external |
| | | | | HOASource the distance is |
| | | | | from the extent boundary into |
| | | | | the region of validity in the |
| | | | | direction of the normal vector. |

TABLE 3
MPEG-I Audio ChannelSource Parameters
ChannelSource

| Child node | Count | Description |
|---|---|---|
| <Loudspeaker> | >=1 | Virtual loudspeaker (see below) |

| Attribute | Type | Flags | Default | Description |
|---|---|---|---|---|
| id | ID | R | | Identifier |
| position | Position | R, M | | Position |
| orientation | Rotation | O, M | (0° 0° 0°) | Orientation |
| cspace | Coordinate | O, M | relative | Spatial frame of reference |
| | space | | | |
| inputLayout | CICP layout | R | | Speaker layout of the original |
| | | | | audio signal |
| active | Boolean | O, M | true | If true, then render this source |
| gainDb | Gain | O, M | 0 | Gain (dB) |
| refDistance | Float >0 | O | 1 | Reference distance (m) (see |
| | | | | comment below) |
| signal | AudioStream | R, M | | Audio stream |
| | ID | | | |
| aparams | Authoring | O | none | Authoring parameters (see 4.12) |
| | parameters | | | |
| mode | Playback | O | continuous | Playback mode {“continuous”, |
| | mode | | | “event”} |
| play | Boolean | O, M | False | Playback enabled? |

For the split render approach as described herein, it may be assumed that there is a low-power end-render device (e.g. AR glasses) and at least one pre-rendering entity (EDGE, powerful UE). Generally, to ensure lowest possible motion-to-sound latency, ideally, all rendering would be performed at the end-render device. However, as the end-render device may not be able to handle the processing, portions of the processing may be performed at more powerful pre-renderer(s). Still, not all of the processing can be performed by the pre-renderer(s) due to the transmission latency between the last pre-renderer in the renderer chain and the end-render device.

In the concept applied herein, it is assumed that applying the digested parameters in some approximative form can be done with fairly low complexity by the end-renderer stage. For instance, if the audio signal is a binaurally pre-rendered signal, it would just mean gain adjusting, filtering or time shifting the two channels. The crux is to get the exact parameters and the exact signals to be filtered with these parameters. It is further assumed that the exact parameter digest and the exact application of the digested parameters can be a fairly complex operation, which cannot be done by the final renderer and only by the pre-renderer(s).

As described herein, it is suggested to split the rendering into at least two portions as follows:

The first portion of the rendering may be done by one or more pre-renderers that receive the audio signal to be rendered plus its metadata. Optionally, (delayed) tracking parameters (3DOF/6DOF) and captured audio from the end-render device may be received. The pre-renderer may render the received audio in response to all parameters and the captured audio to some pre-rendered audio signal. This signal would typically be binauralized audio and, except for the delayed tracking data, be the best possible output signal. Along with that, the pre-renderer may calculate parameters of a (first or higher order) digest renderer model (first digested parameters) of, e.g., gain, spectral shape, time lag, which is essentially a first or higher order Taylor expansion of the function of the digested parameters with respect to the tracking parameters. That is, in some embodiments, the generating the one or more first digested rendering parameters, at the first renderer, as described herein, may further involve calculating the one or more first digested rendering parameters based on (e.g., to represent) an approximated (e.g., first order) (digest) renderer model with respect to the one or more canonical rendering parameters. In some embodiments, the calculating may involve calculating a first or higher order Taylor expansion of a renderer model based on the one or more canonical rendering parameters to obtain the digested rendering parameters. As described above, the first or higher order Taylor expansion of the function of the one or more canonical rendering parameters may also be performed with respect to tracking parameters, if received at the first renderer. Notably, in embodiments relating to chains of renderers involving more than two renderers, the second or further digested rendering parameters may be calculated in a similar manner.

As known by a person skilled in the art, the computation of a Taylor expansion of order n requires the availability of n-th order derivatives of the function to be approximated. Numerically, n-th order derivatives are obtained by evaluating at least n+1 function values. Thus, a pre-renderer must be applied for n+1 ‘probing’ poses (or positions) to calculate such n+1 function values of, e.g., gain, spectral shape, time lag. Using the function values, first order derivatives are approximated by calculating difference quotients between the function value differences and the difference values of the probed pose (or position) parameters like pose angles (or cartesian position coordinate values). Higher order derivatives are calculated according to similar known techniques.

Based on these digest renderer model parameters, the end-renderer may adjust the received pre-binauralized audio signal in response to the tracking parameters. For instance, the left or right binaural audio channel would be gain adjusted by an amount proportional to the first order gain coefficient times the delta amount of a given tracking parameter (which assumes that the Oth order coefficient (constant) has been applied at the pre-renderer). The delta amount is the amount by which the tracking parameter has changed between the value assumed by the pre-renderer and the actual amount known by the end-renderer. Note that the pre-renderer may make extrapolations of the tracking parameter evolution to increase accuracy of the pre-rendered audio. Moreover, the pre-renderer may obtain these extrapolations using additional information, e.g., describing envisioned (or most probable) user position and orientation trajectory (e.g., derived from the data describing scene elements attracting user's attention), user listening environment (e.g., real room dimensions), etc. In some embodiments, the method described herein may further include receiving, at the first renderer, timing information indicative of a delay between the first (pre-renderer) and the second (end) renderer, wherein the processing, at the first renderer, may further be based on the timing information. Notably, in embodiments relating to chains of renderers involving more than two renderers, the timing information may be received at the second to last, that is the last pre-renderer in the chain prior to the end-rendering. That is, in some embodiments, the method may further include receiving, at the second renderer, timing information indicative of a delay between the second and the third renderer, wherein the processing at the second renderer is further based on the timing information.

The timing information may be indicative of, for example, an actual round-trip delay between pre- and end-renderer. Based on this approach, parameters to be transmitted on the interface between pre-renderer (e.g., Renderer B) and end-renderer (e.g., Renderer C) may be
External parameters and signals to pre-renderer:
   Tracking parameters (including user-scene interactions, e.g., “audio zoom”-audio objects of interest-“cocktail party effect”, head-tracking parameters (e.g., pose and/or position))
   Time stamp parameters to find out round-trip delay
   Captured audio from the end-render device
   Extra information available at the end-renderer side only. Description of:
      sound play-back setup (e.g., loudspeaker setup, headphone type and HpTF compensation filters)
      listener-related and personalization data (e.g., personalized HRTFs, listener EQ settings)
      listener environment (e.g., AR: real room reverberation, VR: play area dimensions, background noise level)
      listener pose and/or position (e.g., sited/standing/VR-treadmill/inside of moving vehicle)
To end-renderer:
   Audio content/signals (channels, objects, FOAs, binaural audio, mono audio)
   The accompanying audio signal metadata (e.g., see FOA metadata above, such as sector, mixing coefficients, etc.)
   1st or higher order digest renderer coefficients
   Time stamp parameters to find out round-trip delay

Even another example of metadata that may be transmitted over the interface between renderer instances is related to reverb effects. For instance, a pre-renderer may add reverb according to a certain room model. A sub-sequent renderer (e.g. end renderer) may also have the capability to add reverb. In order to avoid that both renderers add reverb in a concurrent fashion, it may be advantageous to inform the respective other renderer that reverb is being added by one of the instances so that the respective other renderer does not add this effect or at least takes the reverb effect of the other renderer into account. It may also be possible to split the reverb effect between the renderer instances such that the less power-constraint renderer creates the computationally demanding part of the effect (for instance involving high-resolution filters with many taps) while the less capable end-renderer makes just some adjustments to align with the actual situational context at the end user/end rendering device.

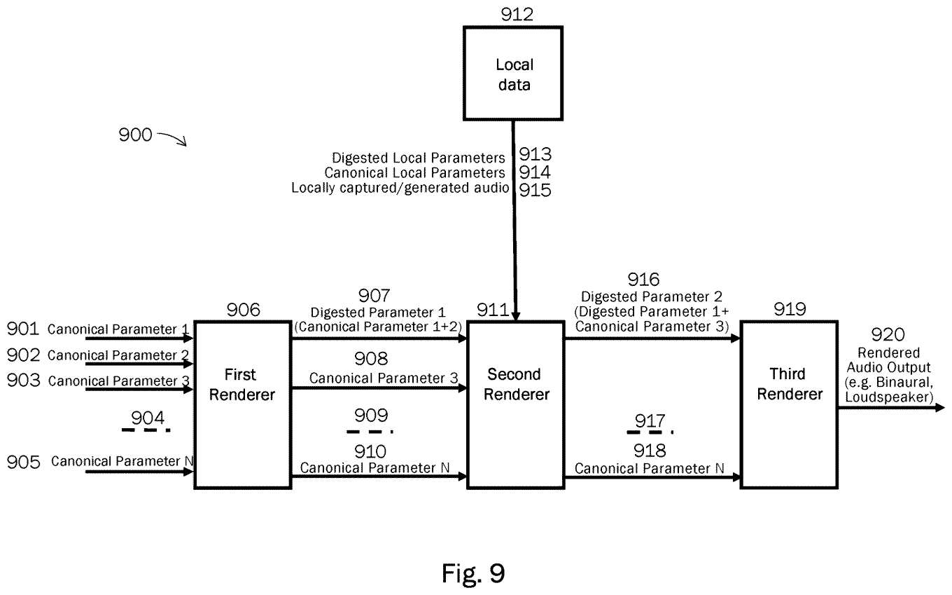

In addition to the digested/canonical parameters and accompanying audio data, locally generated or captured audio 915 may be used as input to various rendering stages as illustrated in the example of FIG. 9. For instance, Renderer B in FIG. 8 could be running on a device (e.g., a smartphone), which also has a microphone for capturing local audio. The “local audio” block may generate accompanying metadata 913, 914 with the locally captured audio 915, which are input into the rendering stages as digested or canonical parameters and are processed as described above. Such metadata could include a capture position in space, either in absolute or relative coordinates. Relative coordinates could be relative to location of a microphone, location of the smartphone, location of a device which is running another rendering stage (e.g. Renderer C running on AR-glasses). In addition, the “Local Audio” block might generate audio data (e.g., Earcon data) and accompanying metadata. Such accompanying metadata associated with locally generated audio 915 may include positions of locally generated audio 915 relative to reference points in a virtual or augmented audio scene. That is, in an embodiment, the first, second and/or third metadata may further include one or more local canonical rendering parameters. In a further embodiment, the first, second and/or third metadata may further include one or more local digested rendering parameters. In a further embodiment, the one or more local canonical rendering parameters or the one or more local digested rendering parameters may be based on one or more device or user parameters including at least one of a device orientation parameter, a user orientation parameter, a device position parameter, a user position parameter, user personalization information or user environment information. In a further embodiment, the first, second or third audio data may further include locally captured or locally generated audio data. The locally captured or locally generated audio data, the local canonical rendering parameters and the local digested rendering parameters may be said to be associated with/derived from local data as described herein.

In addition to the above, the present disclosure describes a further example method of rendering audio. The method may include receiving, at an intermediate renderer, pre-processed metadata and optionally pre-rendered audio data. The pre-processed metadata may include one or more of digested and/or canonical rendering parameters. The method may further include processing, at the intermediate renderer, the pre-processed metadata and optionally the pre-rendered audio data for generating secondary pre-processed metadata and optionally secondary pre-rendered audio data. The processing may include generating one or more secondary digested rendering parameters based on the rendering parameters included in the pre-processed metadata. And the method may include providing, by the intermediate renderer, the secondary pre-processed metadata and optionally the secondary pre-rendered audio data for further processing by a subsequent renderer. The secondary pre-processed metadata may include the one or more secondary digested rendering parameters and optionally one or more of the canonical rendering parameters.

Advantageously, the above described example method may be implemented into already existing renderer chains or implemented to create a respective renderer chain based on an already existing renderer/system.

### Alternative Method and System of Rendering Audio

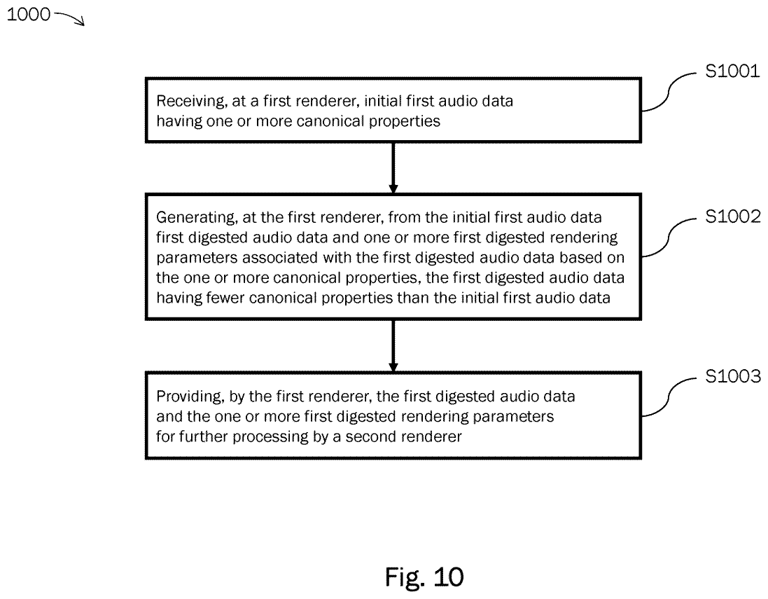

As a further solution to the problems posed, the present disclosure describes an alternative method and system of rendering audio that allow to effectively split the computational burden and at the same time minimize the motion-to-sound latency. An example of said alternative method of (split) rendering (immersive) audio 1000 is illustrated in FIG. 10.

Referring to the example of FIG. 10, in step S1001, initial first audio data having one or more canonical properties are received at a first renderer.

In step S1002, at the first renderer, from the initial first audio data, first digested audio data and one or more first digested rendering parameters associated with the first digested audio data are generated based on the one or more canonical properties, the first digested audio data having fewer canonical properties than the initial first audio data.

And in step S1003, the first renderer provides the first digested audio data and the one or more first digested rendering parameters for further processing by a second renderer.

Generally, audio signals, such as Ambisonics, may be regarded as a ‘canonical’ audio representation. In that sense, the respective audio data may have one or more canonical properties.

In an embodiment, the canonical properties may include one or more of extrinsic and/or intrinsic canonical properties. An extrinsic canonical property may be associated with one or more canonical rendering parameters as already described above.

An intrinsic canonical property may be associated with a property of the audio data to retain the potential to be rendered perfectly in response to an external renderer parameter. For example, a property like scene rotatability of Ambisonics audio is intrinsically canonical, meaning that it allows controlling a certain feature kind like scene orientation independently of other features. The intrinsic canonical property is also associated with the property of the audio signal that it retains the potential to be rendered perfectly in response to an external renderer parameter such as pose. Like in the case with extrinsic canonical parameters, while rendering from a canonical representation is convenient, it may not necessarily lead to the least complex renderer solution. As an example, binaural rendering of Ambisonics audio may still be too complex for a very power limited end device. Thus, rendering an audio signal with intrinsic canonical property on a very power limited end device may be less attractive or not possible.

In an embodiment, the method may further include receiving, at the first renderer, one or more external parameters as described, wherein the generating, at the first renderer, may further be based on the one or more external parameters. The one or more external parameters may include 3DOF/6DOF tracking parameters. The generating, at the first renderer, may then further be based on the tracking parameters.

In an embodiment, the method may further include receiving, at the first renderer, timing information indicative of a delay between the first and the second renderer. The generating/processing, at the first renderer, may then further be based on the timing information. The delay may be calculated at the second renderer.

In an embodiment, the method may yet further include adjusting the tracking parameters based on the timing information, wherein optionally the adjusting may include predicting the tracking parameters based on the timing information. Also the adjusting (predicting) may be performed at the second renderer.

Notably, while this is described to refer to the first and the second renderer, the derivation of delay as well as the prediction may be done at each pre-renderer (node), not only the first. That is, a case with two renderers may be just an example, and the same may apply if more than two renderers are involved in which case round-trip delay measurements may be done between any two renderers and adjusting may also be done anywhere in the renderer chain.

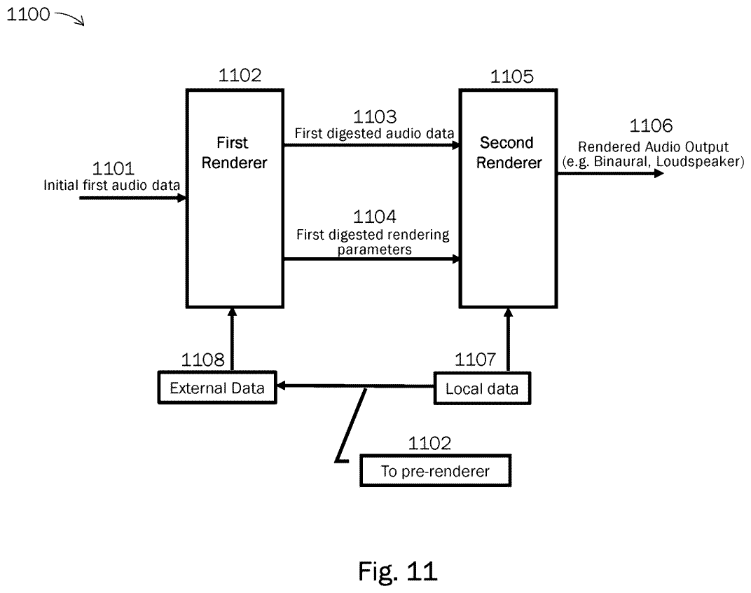

Referring to the example of FIG. 11, an example of a system of rendering audio by a chain of a first and a second renderer to implement the method described is illustrated. In the example of FIG. 11, the system includes a first renderer 1102 that, in an embodiment, may be implemented on one or more servers, for example, in the network or on an EDGE Server, and a second renderer 1105 that may be implemented on one or more user's end devices. In an embodiment, the one or more end devices may be wearable devices.

In the example of FIG. 11, the first renderer 1102 receives initial first audio data 1101. The initial first audio data 1101 may correspond to a canonical audio representation. In that sense, the initial first audio data 1101 have one or more canonical properties. As already detailed above, the one or more canonical properties may include one or more of extrinsic and/or intrinsic canonical properties.

At the first renderer 1102, from the initial first audio data 1101, first digested audio data 1103 and one or more first digested rendering parameters 1104 associated with the first digested audio data 1103 are generated based on the one or more canonical properties, the first digested audio data 1103 having fewer canonical properties than the initial first audio data 1101.

Some or all of the one or more first digested rendering parameters 1104 may be derived from a combination of at least two of the canonical properties of the initial first audio data 1101. Alternatively, or additionally, some or all of the one or more first digested rendering parameters 1104 may be derived from combining at least one of the canonical properties of the initial first audio data 1101 and the respective initial first audio data 1101. Digested rendering parameters may also be obtained from combinations of canonical properties of audio data and external parameters/data 1108 such as, for example, local end device parameters/data 1107 such as pose and position.

Generating the one or more first digested rendering parameters 1104, at the respective first renderer 1102, may further involve calculating the one or more first digested rendering parameters 1004 to represent an approximated renderer model with respect to the one or more canonical properties. The calculating may involve calculating a first or higher order Taylor expansion of a renderer model based on the one or more canonical properties. The calculating of the one or more first digested rendering parameters 1104 may, in an embodiment, involve multiple renderings. That is, multiple renderings may be performed at one renderer (node) of the rendering chain. For example, a pre-renderer, e.g. the first renderer, may render for two hypothetical ‘probing’ poses. Alternatively, or additionally, the calculating of the one or more first digested rendering parameters 1104 may involve analyzing signal properties of the initial first audio data 1101 to identify parameters relating to a sound reception model. This may apply to all renderers in the chain except the last renderer.

For example, digest model parameters may be obtained by analyzing the (canonical) audio signal at a pre-renderer (e.g. the first renderer) in terms of certain signal properties like direction or distance of a dominant sound source and applying a sound reception model (e.g. human head model, distance model) to calculate how the (binaurally) rendered output signal and the associated digested model parameters would change when a change is applied in pose (or position).

While deriving/calculating/generating/obtaining respective digested rendering parameters may be described throughout the disclosure with respect to first or second order, the respective method steps may also be applied for deriving/calculating/generating/obtaining respective higher order digested rendering parameters.

In the example of FIG. 11, the second renderer 1105 may be said to be the final (end) renderer performing the final rendering step. That is, in an embodiment, output audio 1106 may be rendered by the second renderer 1105 based on the first digested audio data 1103 and at least partly based on the one or more first digested rendering parameters 1104. Rendering the output audio by the second renderer may further also be based on one or more local parameters 1107 available at the second renderer. Local parameters may be, for example, head-tracker data. As already described above, in an embodiment, the method may further include receiving, at the first renderer 1102, one or more external parameters 1108. The generating, at the first renderer 1102, may then further be based on the one or more external parameters 1108. The one or more external parameters may include 3DOF/6DOF tracking parameters. The generating, at the first renderer 1102, may then further be based on the tracking parameters.

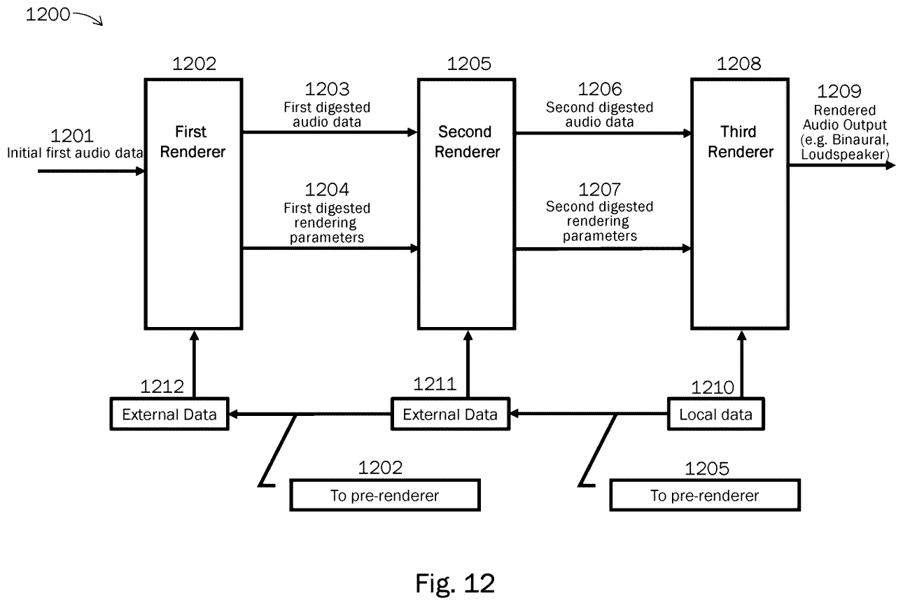

Referring now to the example of FIG. 12, the chain of renderers may also include more than two renderers. In the example of FIG. 12, the chain of renderers includes three renderers. In an embodiment, the first renderer 1202 and the second renderer 1205 may be implemented on one or more servers, for example, in the network and on the EDGE Server. The third renderer 1208 may be implemented on one or more user's end devices. The one or more end devices may be wearable devices.

In contrast to the example of FIG. 11, in this example, the second renderer 1205 represents an intermediate renderer while the third renderer 1208 represents the final renderer performing the final rendering step.

That is, in the example of FIG. 12, at the second renderer 1205, the first digested audio data 1203 and optionally the one or more first digested rendering parameters 1204 may be processed for generating second digested audio data 1206 and one or more second digested rendering parameters 1207. The second digested audio data may have fewer canonical properties than the first digested audio data. This may be said to be due to the successive complexity reduction during the rendering stages.

In an embodiment, the method may further include receiving, at the first renderer 1202 and/or at the second renderer 1205, one or more external parameters 1212, 1211. The generating at the first renderer and/or the processing at the second renderer 1205 may then further be based on the one or more external parameters 1212, 1211. The one or more external parameters 1212, 1211 may include 3DOF/6DOF tracking parameters. The generating at the first renderer 1202 and/or the processing at the second renderer 1205 may then further be based on the tracking parameters.

In an embodiment, the method may further include receiving, at the second renderer, timing information indicative of a delay between the second and the third renderer. The generating/processing, at the second renderer, may then further be based on the timing information. The delay may be calculated at the third renderer.

In an embodiment, the method may yet further include adjusting the tracking parameters based on the timing information, wherein optionally the adjusting may include predicting the tracking parameters based on the timing information. Also the adjusting (predicting) may be performed at the third renderer.

In the example of FIG. 12, the second renderer 1205 provides the second digested audio data 1206 and the one or more second digested rendering parameters 1207 for further processing by the third renderer 1208.

As, in this example, the third renderer 1208 is the final renderer, the further processing by the third renderer 1208 includes rendering output audio 1209 based on the second digested audio data 1206 and at least partly based on the one or more second digested rendering parameters 1207. Rendering the output audio by the third renderer may further also be based on one or more local parameters 1210 available at the third renderer 1208. Local parameters may be, for example, head-tracker data.

In addition to the above, the present disclosure describes a further example method of rendering audio. The method may include receiving, at an intermediate renderer, digested audio data having one or more canonical properties and one or more digested rendering parameters. The method may further include processing, at the intermediate renderer, the digested audio data and optionally the one or more digested rendering parameters for generating secondary digested audio data and one or more secondary digested rendering parameters. The secondary digested audio data may have fewer canonical properties than the digested audio data. And the method may include providing, by the intermediate renderer, the secondary digested audio data and the one or more secondary digested rendering parameters for further processing by a subsequent renderer.

### Apparatus for Implementing Methods According to the Disclosure

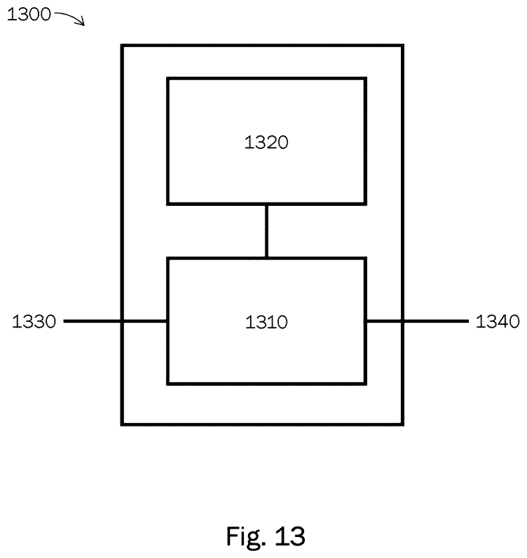

Finally, the present disclosure likewise relates to an apparatus (e.g., computer-implemented apparatus) for performing methods and techniques described throughout the present disclosure. FIG. 13 shows an example of such apparatus 1300. In particular, apparatus 1300 comprises a processor 1310 and a memory 1320 coupled to the processor 1310. The memory 1320 may store instructions for the processor 1310. The processor 1310 may also receive, among others, suitable input data 1330, depending on use cases and/or implementations. The processor 1310 may be adapted to carry out the methods/techniques described throughout the present disclosure and to generate corresponding output data 1340 depending on use cases and/or implementations.

### Interpretation

Aspects of the systems described herein may be implemented in an appropriate computer-based sound processing network environment for processing digital or digitized audio files. Portions of the adaptive audio system may include one or more networks that comprise any desired number of individual machines, including one or more routers (not shown) that serve to buffer and route the data transmitted among the computers. Such a network may be built on various different network protocols, and may be the Internet, a Wide Area Network (WAN), a Local Area Network (LAN), or any combination thereof.

One or more of the components, blocks, processes or other functional components may be implemented through a computer program that controls execution of a processor-based computing device of the system. It should also be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, physical (non-transitory), non-volatile storage media in various forms, such as optical, magnetic or semiconductor storage media.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

Various aspects and implementations of the present disclosure may also be appreciated from the following enumerated example embodiments (EEEs), which are not claims.

EEE1. A method of processing audio, comprising:
receiving, at a first renderer, one or more canonical rendering parameters;
generating, at the first renderer, one or more digested rendering parameters based on the one or more canonical rendering parameters;
providing, by the first renderer to a second renderer, the one or more digested rendering parameters and, optionally, a portion of the one or more canonical rendering parameters; and
rendering audio by the second renderer based on the one or more digested rendering parameters and, optionally, the portion of the one or more canonical rendering parameters.
   EEE2. The method of EEE 1, wherein the first renderer is implemented on one or more servers, and the second renderer is implemented on one or more wearable devices.
   EEE3. The method of EEE 1, wherein the one or more canonical rendering parameters comprise parameters that each controls a feature of the audio independent of other features of the audio.
   EEE4. The method of EEE 1, wherein the one or more digested rendering parameters include one or more of a parameter derived from the one or more canonical parameters or one or more device or user parameters.
   EEE5. The method of EEE 4, wherein the one or more device or user parameters include at least one of a device orientation parameter, a user orientation parameter, a device position parameter, a user position parameter, user personalization information or user environment information.
   EEE6. The method of EEE 1, wherein rendering audio by the second renderer comprises at least one of:
providing, by the second renderer to a third renderer, the one or more digested rendering parameters, one or more additional digested rendering parameters derived from the portion of canonical rendering parameters by the second renderer, and a smaller portion of the one or more canonical rendering parameters; or
providing, by the second renderer, a representation of an audio output to be played by one or more transducers.
   EEE7. The method of EEE 1, comprising generating, by the first renderer based on the one or more canonical rendering parameters, prerendered audio, wherein rendering the audio by the second renderer is based on the prerendered audio.
   EEE8. The method of EEE 7, wherein the prerendered audio includes at least one of monaural audio, binaural audio, multi-channel audio, FOA audio or HOA audio.
   EEE9. The method of EEE 7, comprising generating, by the second renderer based on the one or more digested rendering parameters and, optionally, the portion of the one or more canonical rendering parameters, secondary prerendered audio.
   EEE10. The method of EEE 8, wherein the secondary prerendered audio includes at least one of monaural audio, binaural audio, multi-channel audio, FOA audio or HOA audio.
   EEE11. A system including one or more processors configured to perform operations of any one of EEEs 1-10.
   EEE12. A computer program product configured to cause one or more processors to perform operations of any one of EEEs 1-10.

1. A method of rendering audio, the method including:
receiving, at a first renderer, first audio data and first metadata for the first audio data, the first metadata including one or more canonical rendering parameters;
processing, at the first renderer, the first metadata and optionally the first audio data for generating second metadata and optionally second audio data, wherein the processing includes generating one or more first digested rendering parameters based on the one or more canonical rendering parameters; and
providing, by the first renderer, the second metadata and optionally the second audio data for further processing by a second renderer, the second metadata including the one or more first digested rendering parameters and optionally a first portion of the one or more canonical rendering parameters.

2. The method of claim 1, wherein, some or all of the first digested rendering parameters are derived from a combination of at least two of the canonical rendering parameters.

3. The method of claim 1 or 2, wherein the generating the one or more first digested rendering parameters, at the first renderer, further involves calculating the one or more first digested rendering parameters to represent an approximated renderer model with respect to the one or more canonical rendering parameters.

4. The method of claim 3, wherein the calculating involves calculating a first or higher order Taylor expansion of a renderer model based on the one or more canonical rendering parameters.

5. The method of any of claims 1 to 4, wherein the method further includes receiving, at the first renderer, one or more external parameters, and wherein the processing, at the first renderer, is further based on the one or more external parameters.

6. The method of claim 5, wherein the one or more external parameters include 3DOF/6DOF tracking parameters, and wherein the processing, at the first renderer, is further based on the tracking parameters.

7. The method of any of claims 1 to 6, wherein the method further includes receiving, at the first renderer, timing information indicative of a delay between the first and the second renderer, and wherein the processing, at the first renderer, is further based on the timing information.

8. The method of any of claims 1 to 7, wherein the method further includes, receiving, at the first renderer, captured audio from the second renderer, and wherein the processing, at the first renderer, is further based on the captured audio.

9. The method of any of claims 1 to 8, wherein the further processing by the second renderer includes rendering, at the second renderer, output audio based on the second metadata and optionally the second audio data.

10. The method of claim 9, wherein the rendering, at the second renderer, the output audio is further based on one or more local parameters available at the second renderer.

11. The method of any of claims 1 to 10, wherein the second audio data are primary pre-rendered audio data.

12. The method of claim 11, wherein the primary prerendered audio data include one or more of monaural audio, binaural audio, multi-channel audio, First Order Ambisonics audio or Higher Order Ambisonics audio or combinations thereof.

13. The method of any of claims 1 to 12, wherein the first renderer is implemented on one or more servers, and the second renderer is implemented on one or more end devices.

14. The method of claim 13, wherein the one or more end devices are wearable devices.

15. The method of claim 1,
wherein the further processing by the second renderer includes:
processing, at the second renderer, the second metadata and optionally the second audio data for generating third metadata and optionally third audio data, wherein the processing includes generating one or more second digested rendering parameters based on rendering parameters included in the second metadata; and
providing, by the second renderer, the third metadata and optionally the third audio data for further processing by a third renderer, the third metadata including the one or more second digested rendering parameters and optionally a second portion of the one or more canonical rendering parameters.

16. The method of claim 15, wherein the further processing by the third renderer includes rendering, at the third renderer, output audio based on the third metadata and optionally the third audio data.

17. The method of claim 16, wherein the rendering, at the third renderer, the output audio is further based on one or more local parameters available at the third renderer.

18. The method of any of claims 15 to 17, wherein the method further includes receiving, at the first renderer and/or at the second renderer, one or more external parameters, and wherein the processing, at the first renderer and/or at the second renderer, is further based on the one or more external parameters.

19. The method of claim 18, wherein the one or more external parameters include 3DOF/6DOF tracking parameters, and wherein the processing, at the first renderer and/or at the second renderer, is further based on the tracking parameters.

20. The method of any of claims 15 to 19, wherein the method further includes receiving, at the second renderer, timing information indicative of a delay between the second and the third renderer, and wherein the processing, at the second renderer, is further based on the timing information.

21. The method of any of claims 15 to 20, wherein the method further includes, receiving, at the first renderer, captured audio from the third renderer, and wherein the processing, at the first renderer, is further based on the captured audio.

22. The method of any of claims 15 to 21, wherein the generating the one or more second digested rendering parameters is based on the first portion of the one or more canonical rendering parameters.

23. The method of any of claims 15 to 22, wherein the generating the one or more second digested rendering parameters is further based on the one or more first digested rendering parameters.

24. The method of any of claims 15 to 23, wherein the second portion of the one or more canonical rendering parameters is smaller than the first portion of the one or more canonical rendering parameters.

25. The method of any of claims 15 to 24, wherein the third audio data are secondary pre-rendered audio data.

26. The method of claim 25, wherein the secondary prerendered audio data include one or more of monaural audio, binaural audio, multi-channel audio, First Order Ambisonics audio or Higher Order Ambisonics audio or combinations thereof.

27. The method of any of claims 15 to 26, wherein the first and second renderers are implemented on one or more servers, and the third renderer is implemented on one or more end devices.

28. The method of claim 27, wherein the one or more end devices are wearable devices.

29. The method of any of claims 1 to 28, wherein the canonical rendering parameters are rendering parameters related to independent audio features.

30. The method of any of claims 1 to 29, wherein the generating the one or more digested rendering parameters includes performing scene simplification.

31. The method of any of claims 1 to 30, wherein the first, second and/or third metadata further include one or more local canonical rendering parameters.

32. The method of any of claims 1 to 31, wherein the first, second and/or third metadata further include one or more local digested rendering parameters.

33. The method of claim 31 or 32, wherein the one or more local canonical rendering parameters or the one or more local digested rendering parameters are based on one or more device or user parameters including at least one of a device orientation parameter, a user orientation parameter, a device position parameter, a user position parameter, user personalization information or user environment information.

34. The method of any of claims 1 to 33, wherein the first, second or third audio data further include locally captured or locally generated audio data.

35. A method of rendering audio, the method including:
receiving, at an intermediate renderer, pre-processed metadata and optionally pre-rendered audio data, the pre-processed metadata including one or more of digested and/or canonical rendering parameters;
processing, at the intermediate renderer, the pre-processed metadata and optionally the pre-rendered audio data for generating secondary pre-processed metadata and optionally secondary pre-rendered audio data, wherein the processing includes generating one or more secondary digested rendering parameters based on the rendering parameters included in the pre-processed metadata; and
providing, by the intermediate renderer, the secondary pre-processed metadata and optionally the secondary pre-rendered audio data for further processing by a subsequent renderer, the secondary pre-processed metadata including the one or more secondary digested rendering parameters and optionally one or more of the canonical rendering parameters.

36. A method of rendering audio, the method including:
receiving, at a first renderer, initial first audio data having one or more canonical properties;
generating, at the first renderer, from the initial first audio data first digested audio data and one or more first digested rendering parameters associated with the first digested audio data based on the one or more canonical properties, the first digested audio data having fewer canonical properties than the initial first audio data; and
providing, by the first renderer, the first digested audio data and the one or more first digested rendering parameters for further processing by a second renderer.

37. The method of claim 36, wherein the method further includes receiving, at the first renderer, one or more external parameters, and wherein the generating, at the first renderer, is further based on the one or more external parameters.

38. The method of claim 37, wherein the one or more external parameters include 3DOF/6DOF tracking parameters, and wherein the generating, at the first renderer, is further based on the tracking parameters.

39. The method of any of claims 36 to 38, wherein the method further includes receiving, at the first renderer, timing information indicative of a delay between the first and the second renderer, and wherein the generating, at the first renderer, is further based on the timing information.

40. The method of claim 39, wherein the delay is calculated at the second renderer.

41. The method of claim 39 or 40 in dependence on claim 38, wherein the method further includes adjusting the tracking parameters based on the timing information, wherein optionally the adjusting includes predicting the tracking parameters based on the timing information.

42. The method of claim 41, wherein the adjusting is performed at the second renderer.

43. The method of any of claims 36 to 42, wherein the further processing by the second renderer includes rendering, at the second renderer, output audio based on the first digested audio data and at least partly on the one or more first digested rendering parameters.

44. The method of claim 43, wherein the rendering, at the second renderer, the output audio is further based on one or more local parameters available at the second renderer.

45. The method of claim 36,
wherein the further processing by the second renderer includes:
processing, at the second renderer, the first digested audio data and optionally the one or more first digested rendering parameters for generating second digested audio data and one or more second digested rendering parameters, the second digested audio data having fewer canonical properties than the first digested audio data; and
providing, by the second renderer, the second digested audio data and the one or more second digested rendering parameters for further processing by a third renderer.

46. The method of claim 45, wherein the method further includes receiving, at the first renderer and/or at the second renderer, one or more external parameters, and wherein the generating at the first renderer and/or the processing at the second renderer is further based on the one or more external parameters.

47. The method of claim 46, wherein the one or more external parameters include 3DOF/6DOF tracking parameters, and wherein the generating at the first renderer and/or the processing at the second renderer is further based on the tracking parameters.

48. The method of any of claims 45 to 47, wherein the method further includes receiving, at the second renderer, timing information indicative of a delay between the second and the third renderer, and wherein the processing, at the second renderer, is further based on the timing information.

49. The method of claim 48, wherein the delay is calculated at the third renderer.

50. The method of claim 48 or 49 in dependence on claim 47, wherein the method further includes adjusting the tracking parameters based on the timing information, wherein optionally the adjusting includes predicting the tracking parameters based on the timing information.

51. The method of claim 50, wherein the adjusting is performed at the third renderer.

52. The method of any of claims 45 to 50, wherein the further processing by the third renderer includes rendering, at the third renderer, output audio based on the second digested audio data and at least partly on the one or more second digested rendering parameters.

53. The method of claim 52, wherein the rendering, at the third renderer, the output audio is further based on one or more local parameters available at the third renderer.

54. The method of any of claims 36 to 53 wherein the canonical properties include one or more of extrinsic and/or intrinsic canonical properties;
wherein an extrinsic canonical property is associated with one or more canonical rendering parameters;
and wherein an intrinsic canonical property is associated with a property of the audio data to retain the potential to be rendered perfectly in response to an external renderer parameter.

55. The method of any of claims 36 to 54, wherein some or all of the one or more digested rendering parameters are derived from a combination of at least two canonical properties.

56. The method of any of claims 36 to 55, wherein some or all of the one or more digested rendering parameters are derived from at least one canonical property and respective initial or digested audio data.

57. The method of any of claims 36 to 56, wherein the generating the one or more digested rendering parameters, at the respective renderer, further involves calculating the one or more digested rendering parameters to represent an approximated renderer model with respect to the one or more canonical properties.

58. The method of claim 57, wherein the calculating involves calculating a first or higher order Taylor expansion of a renderer model based on the one or more canonical properties.

59. The method of claim 57 or 58, wherein the calculating of the one or more digested rendering parameters involves multiple renderings.

60. The method of claims 57 to 59, wherein the calculating of the one or more digested rendering parameters involves analyzing signal properties of the initial first audio data to identify parameters relating to a sound reception model.

61. The method of any of claims 36 to 60, wherein the first renderer is implemented on one or more servers.

62. The method of any of claims 36 to 61, wherein the second renderer or the third renderer is implemented on one or more end devices.

63. The method of claim 62, wherein the one or more end devices are wearable devices.

64. A method of rendering audio, the method including:
receiving, at an intermediate renderer, digested audio data having one or more canonical properties and one or more digested rendering parameters;
processing, at the intermediate renderer, the digested audio data and optionally the one or more digested rendering parameters for generating secondary digested audio data and one or more secondary digested rendering parameters, the secondary digested audio data having fewer canonical properties than the digested audio data; and
providing, by the intermediate renderer, the secondary digested audio data and the one or more secondary digested rendering parameters for further processing by a subsequent renderer.

65. A system including one or more processors configured to perform operations of any one of claim 1-34, 35, 36-63 or 64.

66. A program comprising instructions that, when executed by a processor, cause the processor to carry out the method according to any one of claim 1-34, 35, 36-63 or 64.

67. A computer-readable storage medium storing the program according to claim 66.
